(19) United States
(12) Patent Application Publication
(10) Pub. No.: US 2025/0348095 A1
(43) Pub. Date: Nov. 13, 2025

(54) THERMAL FLUID COMBINATION OPTIMIZATION APPARATUS, THERMAL FLUID COMBINATION OPTIMIZATION METHOD, AND NON-TRANSITORY RECORDING MEDIUM RECORDING THERMAL FLUID COMBINATION OPTIMIZATION PROGRAM

(71) Applicant: HONDA MOTOR CO., LTD., Tokyo (JP)

(72) Inventors: Akitoshi UCHIUMI, Tokyo (JP); Masahiro KAMIMURA, Tokyo (JP)

(21) Appl. No.: 19/195,783

(22) Filed: May 1, 2025

(30) Foreign Application Priority Data
May 7, 2024 (JP) 2024-075336

(51) Int. Cl. G05D 23/19

(52) U.S. Cl. CPC G05D 23/1917

(57) ABSTRACT

A thermal fluid combination optimization apparatus includes a temperature control unit configured to supply at least one of types of first thermal fluid, each type having exchanged heat with a corresponding one of supply-side facilities, to any of targets and to perform control to bring a temperature of the any of the targets to a target temperature of the any of the targets, and an optimization unit configured to optimize a combination of one of the targets and an amount of first thermal fluid having exchanged heat with one of the supply-side facilities so as to maximize a total sum of heat quantities to be supplied to the targets.

### CROSS REFERENCE TO RELATED APPLICATIONS

This application claims the foreign priority benefit under 35 U.S.C. § 119 of Japanese patent application No. 2024-075336, filed on May 7, 2024, the disclosure of which is incorporated herein by reference.

### BACKGROUND OF THE INVENTION

### 1. Field of the Invention

The present invention relates to a thermal fluid combination optimization apparatus, a thermal fluid combination optimization method, and a non-transitory recording medium recording a thermal fluid combination optimization program, and in particular relates to setting of a suitable heat exchange combination among facilities.

### 2. Description of the Related Art

JPH04-90043A describes an energy system planning support apparatus. An object of the invention described in JPH04-90043A is to automatically generate a facility configuration in which factors such as equipment lifespan, maintenance, and space saving in addition to cost and capacity are taken into consideration.

However, the technique described in JPH04-90043A was intended to evaluate the economic viability of facilities, and was made without taking into account the efficiency of heat exchange among the facilities.

In another aspect, one of challenges for reducing carbon dioxide emission is effective use of exhaust heat. An advisable way to make effective use of exhaust heat is to supply a thermal fluid heated by a facility with a high temperature to another facility with a lower temperature, thereby heating the other facility. However, studies have not been made for setting of an optimum heat exchange combination among these facilities.

### SUMMARY OF THE INVENTION

To solve the above problem, the present application has an object to provide a thermal fluid combination optimization apparatus, a thermal fluid combination optimization method, and a thermal fluid combination optimization program capable of setting an optimum heat exchange combination among facilities so as to maximize heat quantities to be supplied to facilities to be heated. Then, the present application will ultimately contribute to mitigating or reducing the impact of climate change.

The invention according to claim 1 is a thermal fluid combination optimization apparatus including a temperature control unit configured to supply at least one of types of first thermal fluid, each type having exchanged heat with a corresponding one of supply-side facilities, to any of targets and to perform control to bring a temperature of the any of the targets to a target temperature of the any of the targets, and an optimization unit configured to optimize a combination of one of the targets and an amount of first thermal fluid having exchanged heat with one of the supply-side facilities so as to maximize a total sum of heat quantities to be supplied to the targets.

According to the present invention, it is possible to provide a fluid combination optimization apparatus capable of setting an optimum heat exchange combination among facilities so as to maximize the heat quantities to be supplied to facilities to be heated.

According to the present invention, it is possible to provide a thermal fluid combination optimization apparatus, a thermal fluid combination optimization method, and a thermal fluid combination optimization program which are capable of setting an optimum heat exchange combination among facilities so as to maximize the heat quantities to be supplied to facilities to be heated.

### BRIEF DESCRIPTION OF THE DRAWINGS

FIG. 1 is a block diagram of a thermal fluid combination optimization apparatus according to an embodiment of the present invention.

FIG. 2 includes graphs showing valuable heat quantities in hot energy and cold energy.

FIG. 3 is a graph for explaining a heat quantity having high quality in hot energy.

FIG. 4A is a graph showing exhaust heat in a first case.

FIG. 4B is a graph showing temperature conditions of exhaust heat demands, allocation amounts, and a remainder in the first case.

FIG. 4C is a graph showing heat quantity conditions of the exhaust heat demands, the allocation amounts, and the remainder in a middle stage in the first case.

FIG. 4D is a graph showing the heat quantity conditions of the exhaust heat demands, the allocation amounts, and the remainder in an assumption final stage in the first case.

FIG. 5A is a graph showing exhaust heat in a second case.

FIG. 5B is a graph showing temperature conditions of exhaust heat demands, allocation amounts, and a remainder in the second case.

FIG. 5C is a graph showing heat quantity conditions of the exhaust heat demands, the allocation amounts, and the remainder in a middle stage in the second case.

FIG. 5D is a graph showing the heat quantity conditions of the exhaust heat demands, the allocation amounts, and the remainder in an assumption final stage in the second case.

FIG. 6A is a graph showing exhaust heat in a third case.

FIG. 6B is a graph showing temperature conditions of exhaust heat demands, allocation amounts, and a remainder in the third case.

FIG. 6C is a graph showing heat quantity conditions of the exhaust heat demands, the allocation amounts, and the remainder in a middle stage in the third case.

FIG. 6D is a graph showing the heat quantity conditions of the exhaust heat demands, the allocation amounts, and the remainder in an assumption final stage in the third case.

FIG. 7A is a graph showing exhaust heat in a fourth case.

FIG. 7B is a graph showing temperature conditions of exhaust heat demands, allocation amounts, and a remainder in the fourth case.

FIG. 7C is a graph showing heat quantity conditions of the exhaust heat demands, the allocation amounts, and the remainder in a middle stage in the fourth case.

FIG. 7D is a graph showing the heat quantity conditions of the exhaust heat demands, the allocation amounts, and the remainder in an assumption final stage in the fourth case.

FIG. 8 is a flowchart for explaining processing of supplying thermal fluid of supply-side facilities to targets.

FIG. 9 is a flowchart of processing using types of thermal fluid.

FIG. 10 is a flowchart of processing using types of thermal fluid with piping heat radiation taken into account.

FIG. 11 is a diagram for explaining a plant operation for startup of a third apparatus in advance.

FIG. 12 is a diagram for explaining a plant operation for startup of all facilities.

FIG. 13 is a diagram for explaining a plant operation in a steady state.

FIG. 14 is a diagram for explaining a plant operation around noon.

FIG. 15 is a diagram for explaining a plant operation for shutdown.

FIG. 16 is a diagram for explaining a plant operation for shutdown after a first apparatus and a second apparatus are stopped.

FIG. 17 is a diagram showing process layers for calculating a piping heat radiation quantity.

FIG. 18 is a graph showing an operation pattern A for heat reserve and heat release by a heat reserve unit.

FIG. 19 is a graph showing an operation pattern B for heat reserve and heat release by the heat reserve unit.

### DETAILED DESCRIPTION OF THE EMBODIMENTS

Hereinafter, embodiments for carrying out the present invention will be described in reference to the accompanying drawings.

In the drawings, each element may be drawn enlarged, reduced in size, or simplified as appropriate in order to facilitate understanding of the invention.

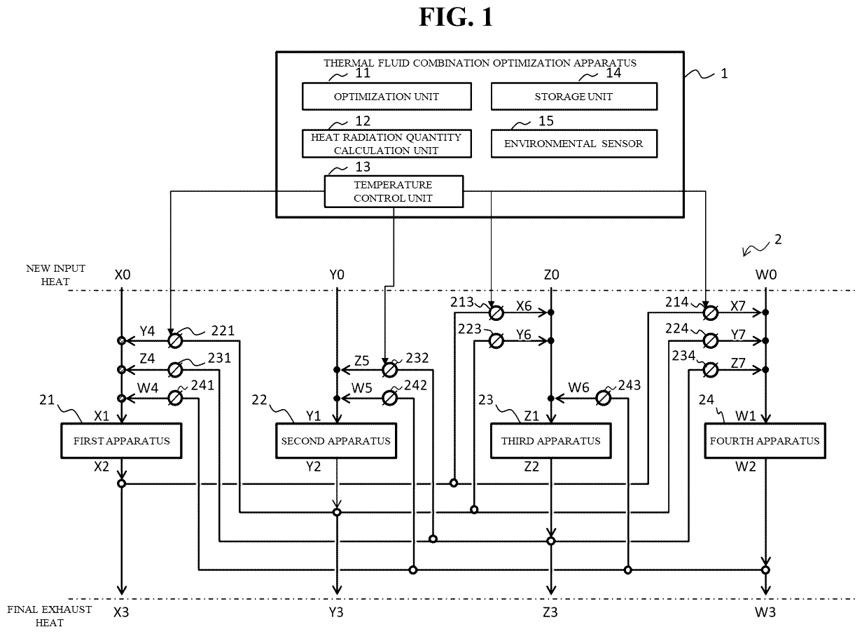

FIG. 1 is a block diagram of a thermal fluid combination optimization apparatus 1 according to an embodiment of the present invention.

The thermal fluid combination optimization apparatus 1 shown in FIG. 1 includes an optimization unit 11, a heat radiation quantity calculation unit 12, a temperature control unit 13, a storage unit 14, and an environmental sensor 15. The thermal fluid combination optimization apparatus 1 sets an optimum heat exchange combination among facilities in a plant 2 and effectively utilizes the exhaust heat of each of the facilities according to this setting.

The optimization unit 11 sets the optimum heat exchange combination among facilities so as to maximize the total sum of the heat quantities supplied to the facilities in the plant 2. The temperature control unit 13 performs control to bring multiple targets into their respective target temperatures, by supplying each of types of thermal fluid that have exchanged heat respectively with multiple supply-side facilities to any of multiple targets. Using types of first thermal fluid that have exchanged heat respectively with multiple supply-side facilities, the temperature control unit 13 repeats heat exchange processing on each of the multiple targets in descending order of the target temperature of the target, by selecting one of the types of thermal fluid that have exchanged heat respectively with the multiple supply-side facilities in ascending order of the temperature of the supply-side facility.

The heat radiation quantity calculation unit 12 calculates a heat quantity of each thermal fluid to be lost through heat radiation when the thermal fluid flows through piping. The storage unit 14 stores heat capacity data of each of the facilities, heat capacity data of each of the thermal fluid, and so on. The environmental sensor 15 detects environmental information, such as weather information, temperature and humidity information, barometric pressure information, and date and time information.

The plant 2 as a control target includes a first apparatus 21, a second apparatus 22, a third apparatus 23, and a fourth apparatus 24.

The first apparatus 21 is supplied with thermal fluid from the other apparatuses via valves 221, 231, and 241 and is also newly supplied with a natural gas and electric power. A heat quantity supplied by the natural gas and the electric power is denoted by X0. Near the valves 221, 231, and 241, flow meters and thermometers are respectively installed to measure the amounts and the temperatures of the thermal fluid to be supplied to the first apparatus 21.

The thermal fluid combination optimization apparatus 1 adjusts the opening ratio of the valve 221, thereby determining how much amount of the thermal fluid heated by the exhaust heat of the second apparatus 22 is to be supplied to the first apparatus 21. In FIG. 1, the heat quantity supplied from the second apparatus 22 is denoted by Y4.

The thermal fluid combination optimization apparatus 1 adjusts the opening ratio of the valve 231, thereby determining how much amount of the thermal fluid heated by the exhaust heat of the third apparatus 23 is to be supplied to the first apparatus 21. In FIG. 1, the heat quantity supplied from the third apparatus 23 is denoted by Z4.

The thermal fluid combination optimization apparatus 1 adjusts the opening ratio of the valve 241, thereby determining how much amount of the thermal fluid heated by the exhaust heat of the fourth apparatus 24 is to be supplied to the first apparatus 21. In FIG. 1, the heat quantity supplied from the fourth apparatus 24 is denoted by W4.

For the first apparatus 21, a heat quantity on an input heat side is denoted by X1 and a heat quantity on an exhaust heat side is denoted by X2. Then, the final exhaust heat of the first apparatus 21 is denoted by X3.

The second apparatus 22 is supplied with thermal fluid from other apparatuses via valves 232 and 242, and is also newly supplied with a natural gas and electric power. A heat quantity supplied by the natural gas and the electric power is denoted by Y0. Near the valves 232 and 242, flow meters and thermometers are respectively installed to measure the amounts and the temperatures of the thermal fluid to be supplied to the second apparatus 22.

The thermal fluid combination optimization apparatus 1 adjusts the opening ratio of the valve 232, thereby determining how much amount of the thermal fluid heated by the exhaust heat of the third apparatus 23 is to be supplied to the second apparatus 22. In FIG. 1, the heat quantity supplied from the third apparatus 23 is denoted by Z5.

The thermal fluid combination optimization apparatus 1 adjusts the opening ratio of the valve 242, thereby determining how much amount of the thermal fluid heated by the exhaust heat of the fourth apparatus 24 is to be supplied to the second apparatus 22. The heat quantity supplied from the third apparatus 23 is denoted by W5.

For the second apparatus 22, a heat quantity on an input heat side is denoted by Y1 and a heat quantity on an exhaust heat side is denoted by Y2. Then, the final exhaust heat of the second apparatus 22 is denoted by Y3.

The third apparatus 23 is supplied with thermal fluid from the other apparatuses via valves 213, 223, and 243, and is also newly supplied with a natural gas and electric power. A heat quantity supplied by the natural gas and the electric power is denoted by Z0. Near the valves 213, 223, and 243, flow meters and thermometers are respectively installed to measure the amounts and the temperatures of the thermal fluid to be supplied to the third apparatus 23.

The thermal fluid combination optimization apparatus 1 adjusts the opening ratio of the valve 213, thereby determining how much amount of the thermal fluid heated by the exhaust heat of the first apparatus 21 is to be supplied to the third apparatus 23. In FIG. 1, the heat quantity supplied from the first apparatus 21 is denoted by X6.

The thermal fluid combination optimization apparatus 1 adjusts the opening ratio of the valve 232, thereby determining how much amount of the thermal fluid heated by the exhaust heat of the second apparatus 22 is to be supplied to the third apparatus 23. In FIG. 1, the heat quantity supplied from the second apparatus 22 is denoted by Y6.

The thermal fluid combination optimization apparatus 1 adjusts the opening ratio of the valve 243, thereby determining how much amount of the thermal fluid heated by the exhaust heat of the fourth apparatus 24 is to be supplied to the third apparatus 23. In FIG. 1, the heat quantity supplied from the fourth apparatus 24 is denoted by W6.

For the third apparatus 23, a heat quantity on an input heat side is denoted by Z1 and a heat quantity on an exhaust heat side is denoted by Z2. Then, the final exhaust heat of the third apparatus 23 is denoted by Z3.

The fourth apparatus 24 is supplied with thermal fluid from the other apparatuses via valves 214, 224, and 234, and is also newly supplied with a natural gas and electric power. A heat quantity supplied by the natural gas and the electric power is denoted by W0. Near the valves 214, 224, and 234, flow meters and thermometers are respectively installed to measure the amounts and the temperatures of the thermal fluid to be supplied to the fourth apparatus 24.

The thermal fluid combination optimization apparatus 1 adjusts the opening ratio of the valve 214, thereby determining how much amount of the thermal fluid heated by the exhaust heat of the first apparatus 21 is to be supplied to the fourth apparatus 24. In FIG. 1, the heat quantity supplied from the first apparatus 21 is denoted by X7.

The thermal fluid combination optimization apparatus 1 adjusts the opening ratio of the valve 224, thereby determining how much amount of the thermal fluid heated by the exhaust heat of the second apparatus 22 is to be supplied to the fourth apparatus 24. In FIG. 1, the heat quantity supplied from the second apparatus 22 is denoted by Y7.

The thermal fluid combination optimization apparatus 1 adjusts the opening ratio of the valve 234, thereby determining how much amount of the thermal fluid heated by the exhaust heat of the third apparatus 23 is to be supplied to the fourth apparatus 24. In FIG. 1, the heat quantity supplied from the third apparatus 23 is denoted by 27.

For the fourth apparatus 24, a heat quantity on an input heat side is denoted by W1 and a heat quantity on an exhaust heat side is denoted by W2. Then, the final exhaust heat of the fourth apparatus 24 is denoted by W3.

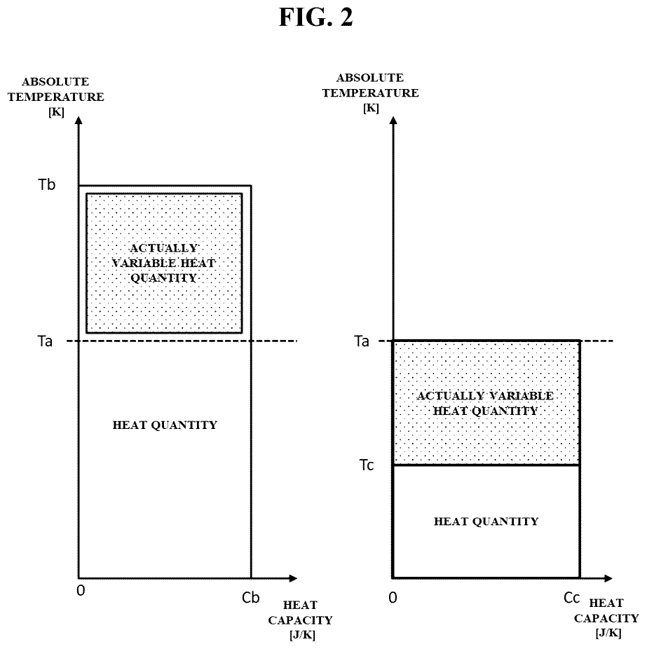

FIG. 2 includes graphs showing valuable heat quantities in hot energy and cold energy.

In each graph shown in FIG. 2, the vertical axis indicates an absolute temperature. The horizontal axis indicates a heat capacity. A temperature Ta indicates a temperature of a target, for example. Of a rectangle representing a heat quantity in the left graph, the height corresponds to a temperature Tb of a supply-side facility, the width corresponds to a heat capacity Cb of the supply-side facility, and the area corresponds to a heat quantity held by the supply-side facility. In the rectangle representing the heat quantity, a portion above the temperature Ta represents a heat quantity actually variable as hot energy out of the heat quantity held by the supply-side facility.

In a rectangle representing a heat quantity in the right graph, the height corresponds to a temperature Tc of a supply-side facility, the width corresponds to a heat capacity Cc of the supply-side facility, and the area corresponds to a heat quantity held by the supply-side facility. A hatched portion having the width of the heat capacity Cc above the temperature Tc and below the temperature Ta corresponds to a heat quantity actually variable as cold energy out of the heat quantity held by the supply-side facility.

Hereinafter, the embodiments will be described for a case where hot energy is to be utilized, but the present invention is not limited to this and may be used for utilization of cold energy.

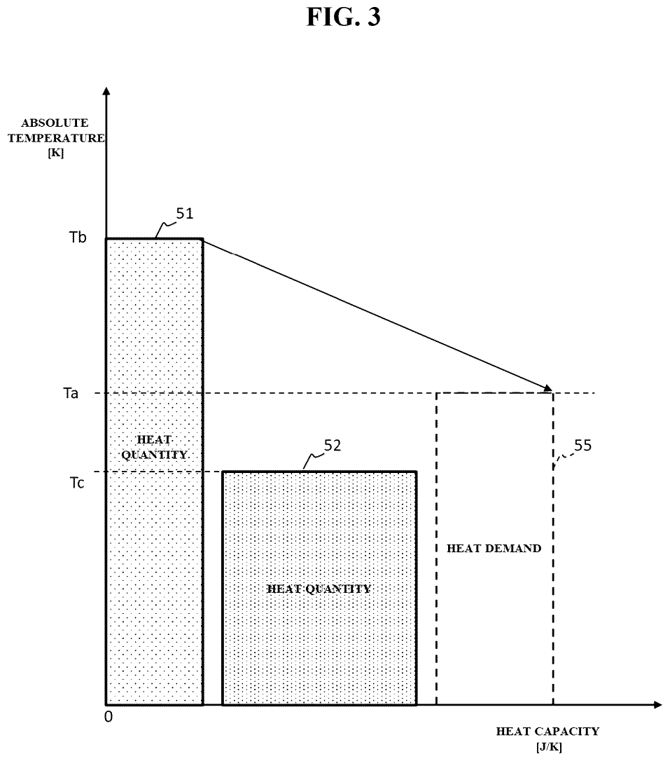

FIG. 3 is a graph for explaining a heat quantity having high quality in hot energy.

A heat quantity 51 is a heat quantity held by a first facility and the temperature of the first facility is Tb. A heat quantity 52 is a heat quantity held by a second facility and the temperature of the second facility is Tc. In this situation, the heat quantity 51 of the first facility is capable of satisfying a heat demand quantity 55 of a target having a target temperature Ta. In contrast, the heat quantity 52 of the second facility is capable of contributing only up to the temperature Tc in the heat demand quantity 55 of the target having the target temperature Ta.

In this situation, the temperature control unit 13 performs control to repeatedly allocate the thermal fluid of the supply-side facility with the lowest temperature to each of target facilities including targets in descending order of the target temperature of the target, and to repeat such allocation in ascending order of the temperature of the supply-side facility.

The number of targets to which the thermal fluid of a supply-side facility with a low temperature can be allocated is smaller than that of the thermal fluid of a supply-side facility with a high temperature. On the other hand, the higher the target temperature of a target, the smaller the number of thermal fluid of supply-side facilities that can be allocated to the above target. This is because thermal fluid of a supply-side facility with a temperature lower than the target temperature of the target cannot give any heat to the target.

For this reason, the temperature control unit 13 assigns a combination of the thermal fluid and target of each of the supply-side facilities in the order in which combinations of targets to which the thermal fluid can be assigned are limited. In this way, the temperature control unit 13 is enabled to reduce the thermal fluid and their heat quantities that cannot be allocated, and find the best allocation without performing exhaustive calculations.

To explain this, the following four cases will be described.

### First Case

In a first case, the temperature control unit 13 repeatedly allocates the thermal fluid of the supply-side facility with the highest temperature to the target facilities including targets one by one in descending order of the target temperature of the target and repeats the above allocation in descending order of the temperature of the supply-side facility. For simplification, herein, it is assumed that there are two supply-side facilities with a high temperature and a low temperature and two targets, namely, a first target with a high target temperature and a second target with a low target temperature.

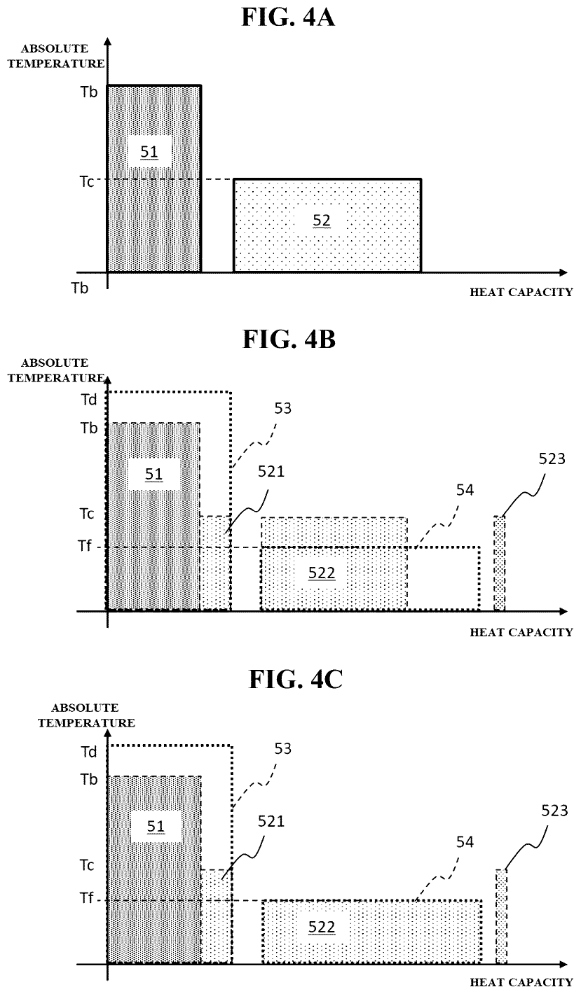

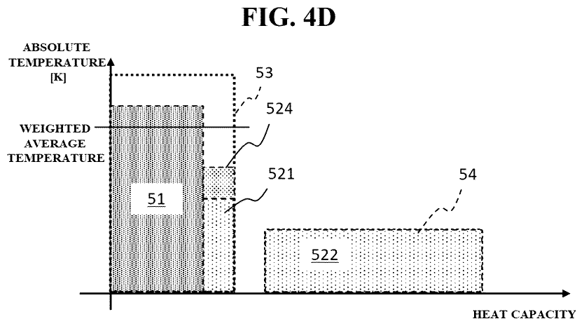

FIG. 4A is a graph showing exhaust heat in the first case.

As shown in FIG. 4A, the supply-side facility with the high temperature discharges a heat quantity 51 of high-temperature thermal fluid. The thermal fluid discharging the heat quantity 51 has a temperature Tb. Meanwhile, the supply-side facility with the low temperature discharges a heat quantity 52 of low-temperature thermal fluid. The thermal fluid discharging the heat quantity 52 has a temperature Tc.

FIG. 4B is a graph showing temperature conditions of exhaust heat demands, allocation amounts, and a remainder in the first case.

As shown in FIG. 4B, a heat demand quantity 53 indicates a heat quantity required for the first target. The height of the heat demand quantity 53 in the graph is a target temperature Td of the first target and the width of the heat demand quantity 53 in the graph is a heat capacity of the first target.

A heat demand quantity 54 indicates a heat quantity required for the second target. The height of the heat demand quantity 54 in the graph is a target temperature Tf of the second target and the width of the heat demand quantity 54 in the graph is a heat capacity of the second target.

The temperature control unit 13 supplies the thermal fluid having the heat quantity 51 of the supply-side facility with the high temperature to the first target having the heat demand quantity 53 with the high target temperature. Subsequently, the temperature control unit 13 supplies the thermal fluid having a heat quantity 521, which is a portion of the heat quantity 52 of the supply-side facility with the low temperature, to the first target having the heat demand quantity 53 with the high target temperature. Then, the temperature control unit 13 supplies the thermal fluid having a heat quantity 522, which is a portion of the heat quantity 52 of the supply-side facility with the low temperature, to the second target having the heat demand quantity 54 with the low target temperature. The heating medium having a heat quantity 523 is a remainder.

FIG. 4C is a graph showing heat quantity conditions of the exhaust heat demands, the allocation amounts, and the remainder in a middle stage in the first case.

As shown in the graph of FIG. 4C, the heat quantity 522 divided from the heat quantity 52 has an area equal to the area of the heat demand quantity 54. With the thermal fluid having the heat quantity 522 supplied to the second target by the temperature control unit 13, the heat quantity 522 is leveled and heats the second target to the target temperature Tf, so that the entire heat demand quantity 54 can be satisfied.

FIG. 4D is a graph showing the heat quantity conditions of the exhaust heat demands, the allocation amounts, and the remainder in an assumption final stage in the first case.

As shown in FIG. 4D, in this assumption final stage, the remaining thermal fluid having the heat quantity 523 is heated by, for example, a heat pump, and then is supplied to a heat quantity 524 in the heat demand quantity 53.

This first case has defects of requiring a large amount of calculation and generating unused thermal fluid in the middle stage.

### Second Case

In a second case, the temperature control unit 13 repeatedly allocates the thermal fluid of the supply-side facility with the lowest temperature to the target facilities including targets by one in descending order of the target temperature of the target, and repeats this allocation in ascending order of the temperature of the supply-side facility. For simplification, herein, it is assumed that there are two supply-side facilities with a high temperature and a low temperature and two targets, namely, a first target with a high target temperature and a second target with a low target temperature.

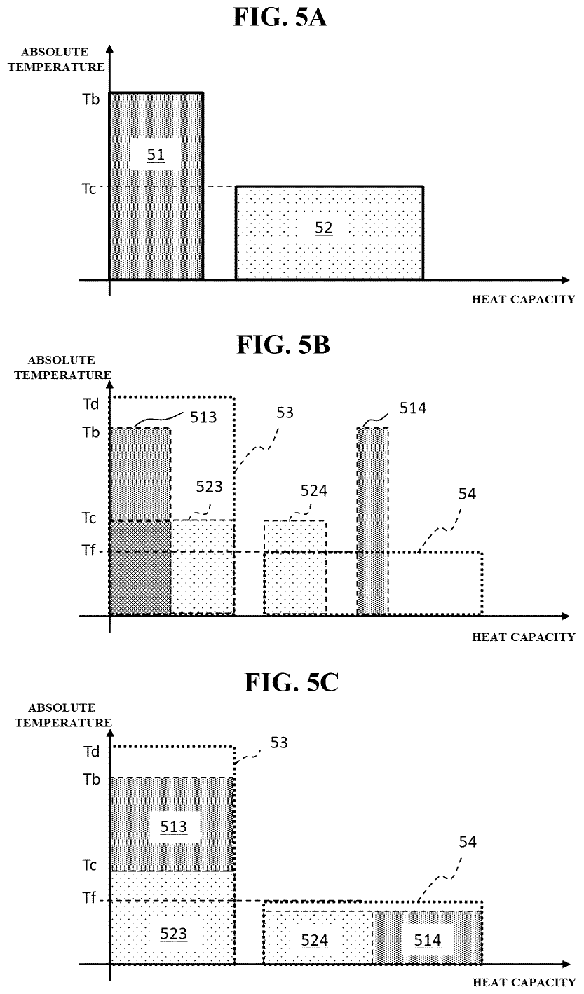

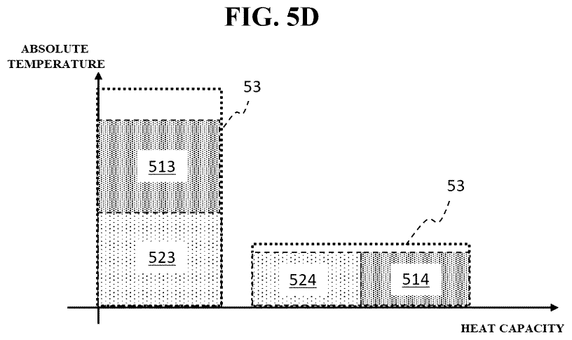

FIG. 5A is graph showing exhaust heat in the second case.

As shown in FIG. 5A, the supply-side facility with the high temperature discharges a heat quantity 51 of high-temperature thermal fluid. The thermal fluid discharging the heat quantity 51 has a temperature Tb. Meanwhile, the supply-side facility with the low temperature discharges a heat quantity 52 of low-temperature thermal fluid. The thermal fluid discharging the heat quantity 52 has a temperature Tc.

FIG. 5B is a graph showing temperature conditions of exhaust heat demands, allocation amounts, and a remainder in the second case.

As shown in FIG. 5B, a heat demand quantity 53 indicates a heat quantity required for the first target. The height of the heat demand quantity 53 is a target temperature Td of the first target and the width of the heat demand quantity 53 is a heat capacity of the first target.

A heat demand quantity 54 indicates a heat quantity required for the second target. The height of the heat demand quantity 54 in the graph is a target temperature Tf of the second target and the width of the heat demand quantity 54 in the graph is a heat capacity of the second target.

The temperature control unit 13 supplies partial thermal fluid having a heat quantity 523 of the supply-side facility with the low temperature to the first target to the maximum possible extent to heat the first target to the temperature Tc, and supplies the remaining thermal fluid having a heat quantity 524 of the supply-side facility with the low temperature to the second target. Moreover, the temperature control unit 13 supplies partial thermal fluid having a heat quantity 513 of the supply-side facility with the high temperature to the maximum possible extent to the first target and supplies the remaining thermal fluid having a heat quantity 514 of the supply-side facility with the high temperature to the second target.

FIG. 5C is a graph showing heat quantity conditions of the exhaust heat demands, the allocation amounts, and the remainder in a middle stage in the second case.

As shown in FIG. 5C, the first target can be heated to the temperature Tc with the heat quantity 523 of the thermal fluid supplied to the first target out of the thermal fluid having the heat quantity 52. In that state, the first target can be heated to the temperature Tb with the heat quantity 514 of the thermal fluid supplied to the first target out of the thermal fluid having the heat quantity 51.

The second target can be heated nearly to the target temperature Tf with the heat quantity 524 of the thermal fluid supplied to the second target out of the thermal fluid having the heat quantity 52 and the heat quantity 514 of the thermal fluid supplied to the second target out of the thermal fluid having the heat quantity 51.

FIG. 5D is a graph showing the heat quantity conditions of the exhaust heat demands, the allocation amounts, and the remainder in an assumption final stage in the second case.

As shown in FIG. 5D, since no remaining thermal fluid is generated in this second case, the heating amount conditions in the assumption final stage have no change.

This second case is the best because it involves only a small amount of calculation and generates no unused thermal fluid in the middle stage.

### Third Case

In a third case, the temperature control unit 13 repeatedly allocates the thermal fluid of the supply-side facility with the highest temperature to the target facilities including targets one by one in ascending order of the target temperature of the target and repeats this allocation in descending order of the temperature of the supply-side facility. For simplification, herein, it is assumed that there are two supply-side facilities with a high temperature and a low temperature and two targets, namely, a first target with a high target temperature and a second target with a low target temperature.

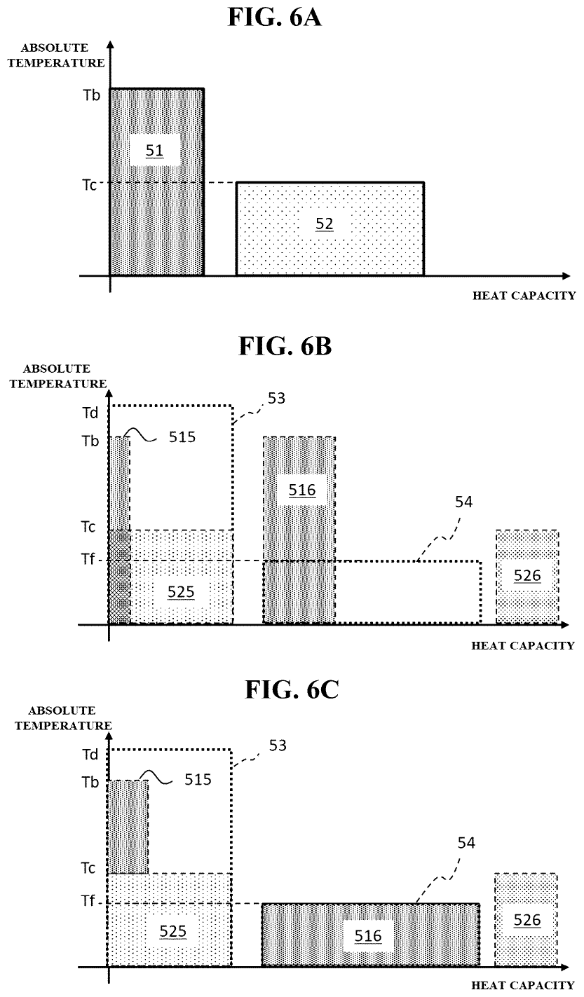

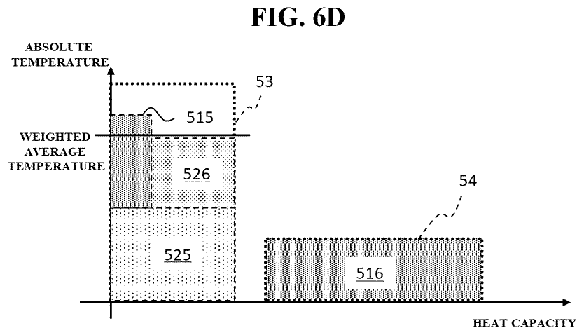

FIG. 6A is a graph showing exhaust heat in the third case. As shown in FIG. 6A, the supply-side facility with the high temperature discharges a heat quantity 51 of high-temperature thermal fluid. The thermal fluid discharging the heat quantity 51 has a temperature Tb. Meanwhile, the supply-side facility with the low temperature discharges a heat quantity 52 of low-temperature thermal fluid. The thermal fluid discharging the heat quantity 52 has a temperature Tc.

FIG. 6B is a graph showing temperature conditions of exhaust heat demands, allocation amounts, and a remainder in the third case.

As shown in FIG. 6B, a heat demand quantity 53 indicates a heat quantity required for the first target. The height of the heat demand quantity 53 is a target temperature Td of the first target and the width of the heat demand quantity 53 is a heat capacity of the first target.

A heat demand quantity 54 indicates a heat quantity required for the second target. The height of the heat demand quantity 54 in the graph is a target temperature Tf of the second target and the width of the heat demand quantity 54 in the graph is a heat capacity of the second target.

The temperature control unit 13 supplies partial thermal fluid having a heat quantity 516 of the supply-side facility with the high temperature to the second target having the heat demand quantity 54 with the low target temperature. In this state, the heat demand quantity 54 required for the second target is satisfied. Next, the temperature control unit 13 supplies the remaining thermal fluid having a heat quantity 515 of the supply-side facility with the high temperature to the first target having the heat demand quantity 53 having the high target temperature.

The temperature control unit 13 supplies partial thermal fluid having a heat quantity 525 of the supply-side facility with the low temperature to the first target having the heat demand quantity 53 with the high target temperature. The remaining thermal fluid of the supply-side facility with low temperature has a heat quantity 526.

FIG. 6C is a graph showing heat quantity conditions of the exhaust heat demands, the allocation amounts, and the remainder in a middle stage in the third case.

As shown in FIG. 6C, the first target can be heated to the temperature Tc with the heat quantity 525 of the thermal fluid supplied to the first target out of the thermal fluid having the heat quantity 52. In this state, the first target can be further heated with the heat quantity 515 of the thermal fluid supplied to the first target out of the thermal fluid having the heat quantity 51.

The second target can be heated to the target temperature Tf with the heat quantity 516 of the thermal fluid supplied to the second target out of the thermal fluid having the heat quantity 51.

FIG. 6D is a graph showing the heat quantity conditions of the exhaust heat demands, the allocation amounts, and the remainder in an assumption final stage in the third case.

As shown in FIG. 6D, the heat quantity 526 is obtained by further heating the first target with the heat quantity of the remaining thermal fluid heated by a heat pump or the like. Thus, the first target can be heated to a weighted average temperature or higher.

This third case has defects of requiring a large amount of calculation and generating unused thermal fluid in the middle stage.

### Fourth Case

In a fourth case, the temperature control unit 13 repeatedly allocates the thermal fluid of the supply-side facility with the lowest temperature to the target facilities including targets one by one in ascending order of the target temperature, and repeats this allocation in ascending order of the temperature of the supply-side facility. For simplification, herein, it is assumed that there are two supply-side facilities with a high temperature and a low temperature and two targets, namely, a first target with a high target temperature and a second target with a low target temperature.

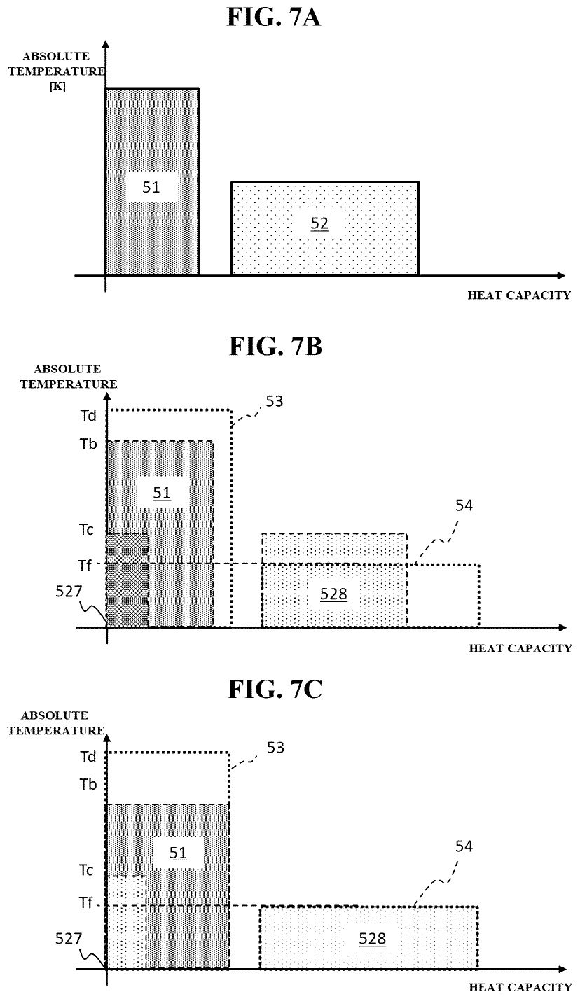

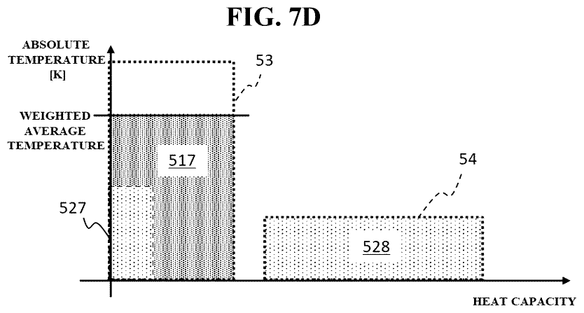

FIG. 7A is a graph showing exhaust heat in the fourth case.

As shown in FIG. 7A, the supply-side facility with the high temperature discharges a heat quantity 51 of high-temperature thermal fluid. The thermal fluid discharging the heat quantity 51 has a temperature Tb. Meanwhile, the supply-side facility with the low temperature discharges a heat quantity 52 of low-temperature thermal fluid. The thermal fluid discharging the heat quantity 52 has a temperature Tc.

FIG. 7B is a graph showing temperature conditions of exhaust heat demands, allocation amounts, and a remainder in the fourth case.

As shown in FIG. 7B, a heat demand quantity 53 indicates a heat quantity required for the first target. The height of the heat demand quantity 53 is a target temperature Td of the first target and the width of the heat demand quantity 53 is a heat capacity of the first target.

A heat demand quantity 54 indicates a heat quantity required for the second target. The height of the heat demand quantity 54 in the graph is a target temperature Tf of the second target and the width of the heat demand quantity 54 in the graph is a heat capacity of the second target.

The temperature control unit 13 supplies partial thermal fluid having a heat quantity 528 of the supply-side facility with the low temperature to the second target having the heat demand quantity 54 with the low target temperature. In this state, the heat demand quantity 54 required for the second target is satisfied. Next, the temperature control unit 13 supplies the remaining thermal fluid having a heat quantity 527 of the supply-side facility with the low temperature to the first target having the heat demand quantity 53 with the high target temperature.

Moreover, the temperature control unit 13 supplies all the thermal fluid having the heat quantity 51 of the supply-side facility with the high temperature to the first target having the heat demand quantity 53 with the high target temperature.

FIG. 7C is a graph showing heat quantity conditions of the exhaust heat demands, the allocation amounts, and the remainder in a middle stage in the fourth case.

As shown in FIG. 7C, the first target can be heated to a certain temperature with the heat quantity 527 of the thermal fluid supplied to the first target out of the thermal fluid having the heat quantity 52. In that state, with the thermal fluid having the heat quantity 51, the first target can be further heated to a temperature higher than the certain temperature.

The second target can be heated to the target temperature Tf with the heat quantity 528 of the thermal fluid supplied to the second target out of the thermal fluid having the heat quantity 52.

FIG. 7D is a graph showing the heat quantity conditions of the exhaust heat demands, the allocation amounts, and the remainder in an assumption final stage in the fourth case.

As shown in FIG. 7D, since no remaining thermal fluid is generated in this fourth case, the heating amount conditions in the assumption final stage have no change.

This fourth case has an advantage of involving only a small amount of calculation but also has a defect of causing an intensive shortage condition.

As can be understood from comparisons between the first and third cases and between the second and fourth cases, the remaining thermal fluid increases as a result of supplying the thermal fluid to the targets in ascending order of the target temperature.

In addition, as can be understood from the comparisons between the first and second cases and between the third and fourth cases, as a result of allocating the thermal fluid to the targets in descending order of the temperature of the supply-side facility, the thermal fluid of the supply-side facility with the low temperature remains. Thus, it can be understood that the second case achieves the best allocation.

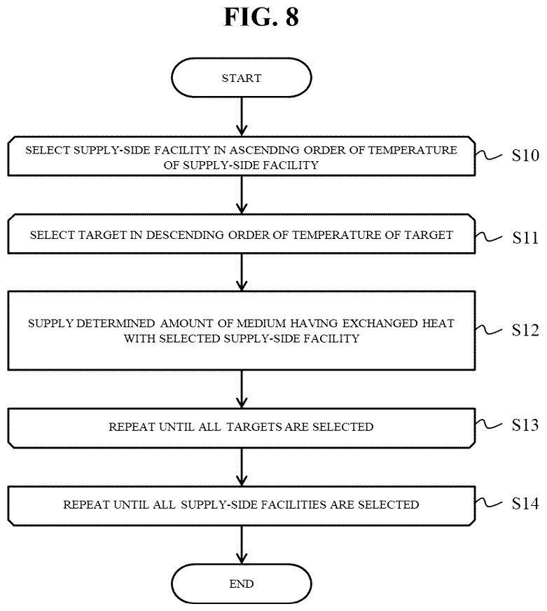

FIG. 8 is a flowchart for explaining processing of supplying thermal fluid of supply-side facilities to targets.

As shown in FIG. 8, first, the temperature control unit 13 selects one of the supply-side facilities in ascending order of the temperature of the supply-side facility (step S10). Next, the temperature control unit 13 selects one of the targets in descending order of the target temperature of the target (step S11).

The temperature control unit 13 supplies the target with just a determined amount of the medium that has exchanged heat with the selected supply-side facility (step S12).

The temperature control unit 13 determines whether or not all the targets are already selected (step S13). The temperature control unit 13 returns to step S11 if there is a target yet to be selected, or proceeds to step S14 if all the targets are already selected.

In step S14, the temperature control unit 13 determines whether or not all the supply-side facilities are already selected. The temperature control unit 13 returns to step S10 if there is a supply-side facility yet t be selected, or terminates the processing in FIG. 8 if all the supply-side facilities are already selected.

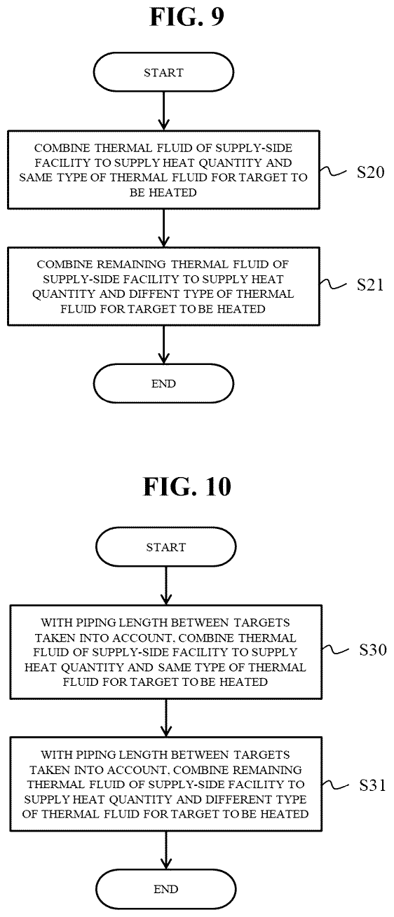

FIG. 9 is a flowchart of processing using types of thermal fluid.

As shown in FIG. 9, the temperature control unit 13 makes a combination of first thermal fluid of a supply-side facility to supply a heat quantity with second thermal fluid of a target to be heated, where the first and second thermal fluid are of the same type (step S20). Here, the first thermal fluid and the second thermal fluid exchange the heat quantity with a heat exchanger not shown. Then, the temperature control unit 13 makes a combination of the remainder of the first thermal fluid of the supply-side facility to supply the heat quantity and second thermal fluid of a target to be heated, where the first and second thermal fluid are of different types (step S21), and terminates the processing in FIG. 9.

FIG. 10 is a flowchart of processing using types of thermal fluid with piping heat radiation taken into account.

As shown in FIG. 10, with a piping length between each pair of targets taken into account, the temperature control unit 13 makes a combination of first thermal fluid of a supply-side facility to supply a heat quantity with second thermal fluid of a target to be heated, where the first and second thermal fluid are of the same type (step S30). Then, with the piping length between each pair of targets taken into account, the temperature control unit 13 makes a combination of the remainder of the first thermal fluid of the supply-side facility to supply the heat quantity and second thermal fluid of a target to be heated, where the first and second thermal fluid are of different types (step S31), and terminates the processing in FIG. 10.

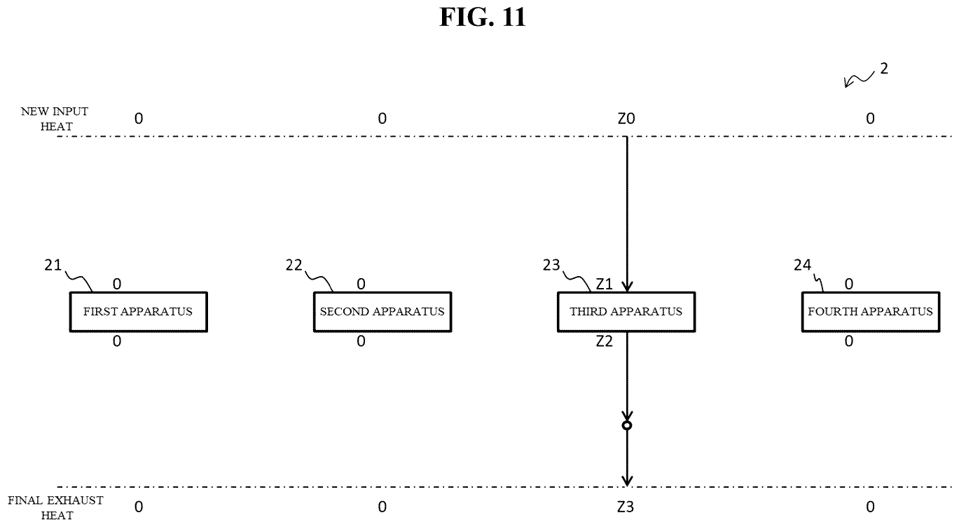

FIG. 11 is a diagram for explaining an operation in the plant 2 for startup of the third apparatus 23 in advance.

As shown in FIG. 11, first, the temperature control unit 13 supplies the third apparatus 23 with a natural gas in an amount equivalent to a heat quantity Z0. The energy input to the third apparatus 23 is equivalent to a heat quantity Z1. The energy output from the third apparatus 23 is equivalent to a heat quantity Z2. The exhaust heat of the third apparatus 23 has a heat quantity Z3.

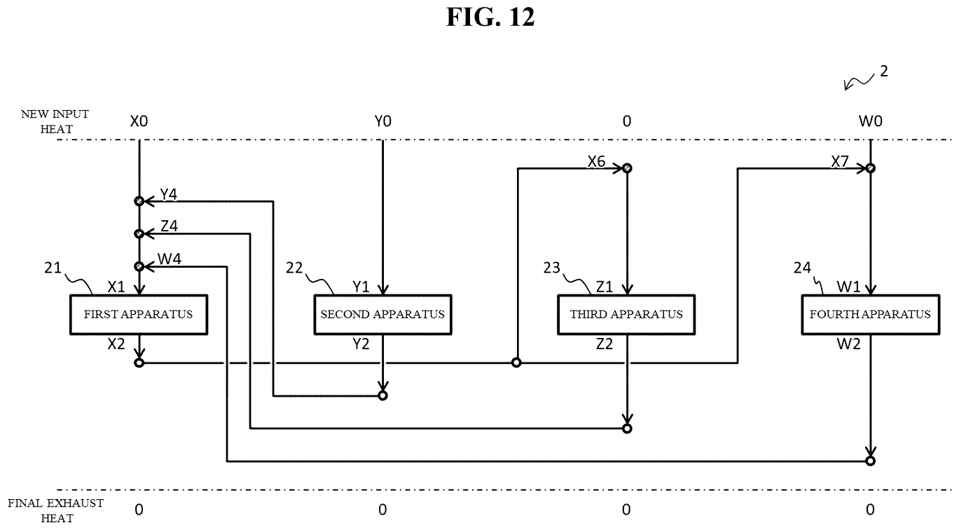

FIG. 12 is a diagram for explaining an operation in the plant 2 for startup of all the apparatuses.

As shown in FIG. 12, the temperature control unit 13 supplies the first apparatus 21 with a natural gas in an amount equivalent to a heat quantity X0. Moreover, the temperature control unit 13 supplies the first apparatus 21 with a heat quantity Y4 of thermal fluid heated by the second apparatus 22, a heat quantity Z4 of thermal fluid heated by the third apparatus 23, and a heat quantity W4 of thermal fluid heated by the fourth apparatus 24. As a result, the first apparatus 21 is supplied with a heat quantity X1 equal to the sum of the heat quantities (X0+Y4+Z4+W4). The first apparatus 21 heats the thermal fluid and outputs a heat quantity X2. Out of the thermal fluid having the heat quantity X2, a portion having a heat quantity X6 is supplied to the third apparatus 23 and a portion having a heat quantity X7 is supplied to the fourth apparatus 24.

The temperature control unit 13 supplies the second apparatus 22 with a natural gas in an amount equivalent to a heat quantity Y0. The second apparatus 22 is supplied with a heat quantity Y1 equivalent to the heat quantity Y0. The second apparatus 22 heats the thermal fluid and outputs a heat quantity Y2. The thermal fluid having the heat quantity Y2 is supplied to the first apparatus 21. That is, the heat quantity Y2 is equal to the heat quantity Y4.

The temperature control unit 13 supplies the third apparatus 23 with a portion of the thermal fluid heated by the first apparatus 21, thereby supplying the third apparatus 23 with a heat quantity X6. A heat quantity Z1 on the input side of the third apparatus 23 is equal to the heat quantity X6. The third apparatus 23 heats the thermal fluid and outputs a heat quantity Z2. The thermal fluid having the heat quantity Z2 is supplied to the first apparatus 21. That is, the heat quantity Z2 is equal to the heat quantity Z4.

The temperature control unit 13 supplies the fourth apparatus 24 with a portion of the thermal fluid heated by the first apparatus 21, thereby supplying the fourth apparatus 24 with a heat quantity X7. A heat quantity W1 on the input side of the fourth apparatus 24 is equal to the sum of the heat quantities (X7+W0). The fourth apparatus 24 heats the thermal fluid and outputs a heat quantity W2. The thermal fluid having the heat quantity W2 is supplied to the first apparatus 21. That is, the heat quantity W2 is equal to the heat quantity W4.

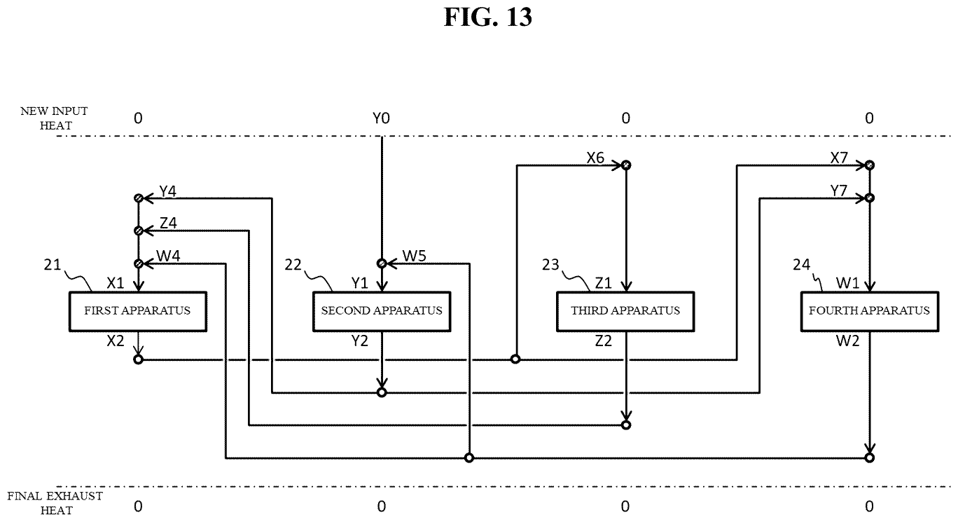

FIG. 13 is a diagram for explaining an operation in the plant 2 in a steady state.

As shown in FIG. 13, the temperature control unit 13 supplies the first apparatus 21 with a heat quantity Y4 of thermal fluid heated by the second apparatus 22, a heat quantity Z4 of thermal fluid heated by the third apparatus 23, and a heat quantity W4 of thermal fluid heated by the fourth apparatus 24. The first apparatus 21 is supplied with a heat quantity X1 equivalent to the sum of the heat quantities (Y4+Z4+W4). The first apparatus 21 heats the thermal fluid and outputs a heat quantity X2. Out of the thermal fluid having the heat quantity X2, a portion having a heat quantity X6 is supplied to the third apparatus 23 and a portion having a heat quantity X7 is supplied to the fourth apparatus 24.

The temperature control unit 13 supplies the second apparatus 22 with a natural gas in an amount equivalent to a heat quantity Y0, and with a heat quantity W5 of the thermal fluid heated by the fourth apparatus 24. Thus, the second apparatus 22 is supplied with a heat quantity Y1 equivalent to the sum of the heat quantities (Y0+W5). The second apparatus 22 heats the thermal fluid and outputs a heat quantity Y2. The thermal fluid having the heat quantity Y2 is supplied to the first apparatus 21 and the fourth apparatus 24. Thus, the heat quantity Y2 is equal to the sum of the heat quantities (Y4+Y7).

The temperature control unit 13 supplies the third apparatus 23 with a portion of the thermal fluid heated by the first apparatus 21, thereby supplying the third apparatus 23 with a heat quantity X6. A heat quantity Z1 on the input side of the third apparatus 23 is equal to the heat quantity X6. The third apparatus 23 heats the thermal fluid and outputs a heat quantity Z2. The thermal fluid having the heat quantity Z2 is supplied to the first apparatus 21 and the fourth apparatus 24. Thus, the heat quantity Z2 is equal to the sum of the heat quantities (Z4+Z7).

The temperature control unit 13 supplies the fourth apparatus 24 with a heat quantity X7 of a portion of the thermal fluid heated by the first apparatus 21, and with a heat quantity Y7 of a portion of the thermal fluid heated by the second apparatus 22. A heat quantity W1 on the input side of the fourth apparatus 24 is equal to the sum of the heat quantities (X7+Y7). The fourth apparatus 24 heats the thermal fluid and outputs a heat quantity W2. The thermal fluid having the heat quantity W2 is supplied to the first apparatus 21 and the second apparatus 22. Thus, the heat quantity W2 is equal to the sum of the heat quantities (W4+W5).

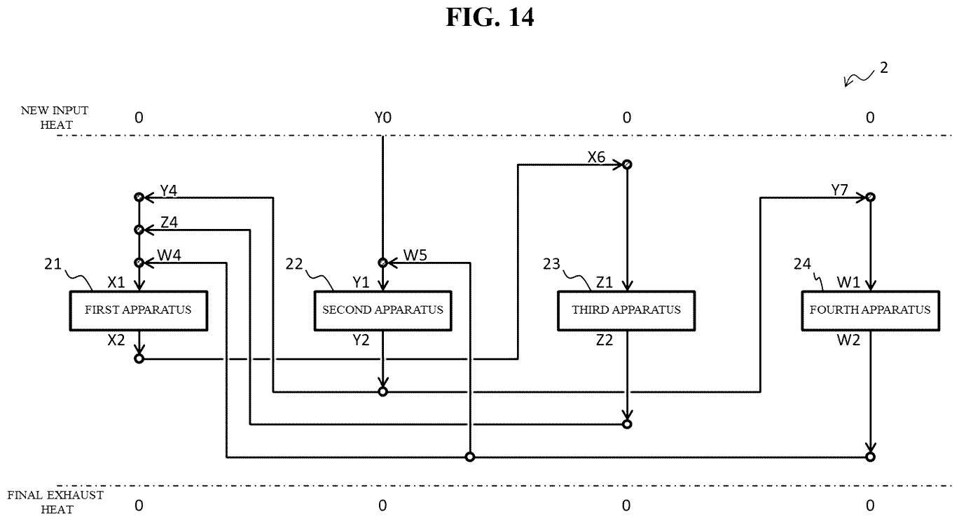

FIG. 14 is a diagram for explaining an operation in the plant 2 around noon.

As shown in FIG. 14, the temperature control unit 13 supplies the first apparatus 21 with a heat quantity Y4 of thermal fluid heated by the second apparatus 22, a heat quantity Z4 of thermal fluid heated by the third apparatus 23, and a heat quantity W4 of thermal fluid heated by the fourth apparatus 24. The first apparatus 21 is supplied with a heat quantity X1 equivalent to the sum of the heat quantities (Y4+Z4+W4). The first apparatus 21 heats the thermal fluid and outputs a heat quantity X2. The thermal fluid having the heat quantity X2 is supplied to the third apparatus 23. Thus, the heat quantity X2 is equal to the heat quantity X6.

The temperature control unit 13 supplies the second apparatus 22 with a natural gas in an amount equivalent to a heat quantity Y0 and with a heat quantity W5 of the thermal fluid heated by the fourth apparatus 24. Thus, the second apparatus 22 is supplied with a heat quantity Y1 equivalent to the sum of the heat quantities (Y0+W5). The second apparatus 22 heats the thermal fluid and outputs a heat quantity Y2. The thermal fluid having the heat quantity Y2 is supplied to the first apparatus 21 and the fourth apparatus 24. Thus, the heat quantity Y2 is equal to the sum of the heat quantities (Y4+Y7).

The temperature control unit 13 supplies the third apparatus 23 with a portion of the thermal fluid heated by the first apparatus 21, thereby supplying the third apparatus 23 with a heat quantity X6. A heat quantity Z1 on the input side of the third apparatus 23 is equal to the heat quantity X6. The third apparatus 23 heats the thermal fluid and outputs a heat quantity Z2. The thermal fluid having the heat quantity Z2 is supplied to the first apparatus 21. Thus, the heat quantity Z2 is equal to the heat quantity Z4.

The temperature control unit 13 supplies the fourth apparatus 24 with a portion of the thermal fluid heated by the second apparatus 22, thereby supplying the fourth apparatus 24 with a heat quantity Y7. A heat quantity W1 on the input side of the fourth apparatus 24 is equal to the heat quantity Y7. The fourth apparatus 24 heats the thermal fluid and outputs a heat quantity W2. The thermal fluid having the heat quantity W2 is supplied to the first apparatus 21 and the second apparatus 22. Thus, the heat quantity W2 is equal to the sum of the heat quantities (W4+W5).

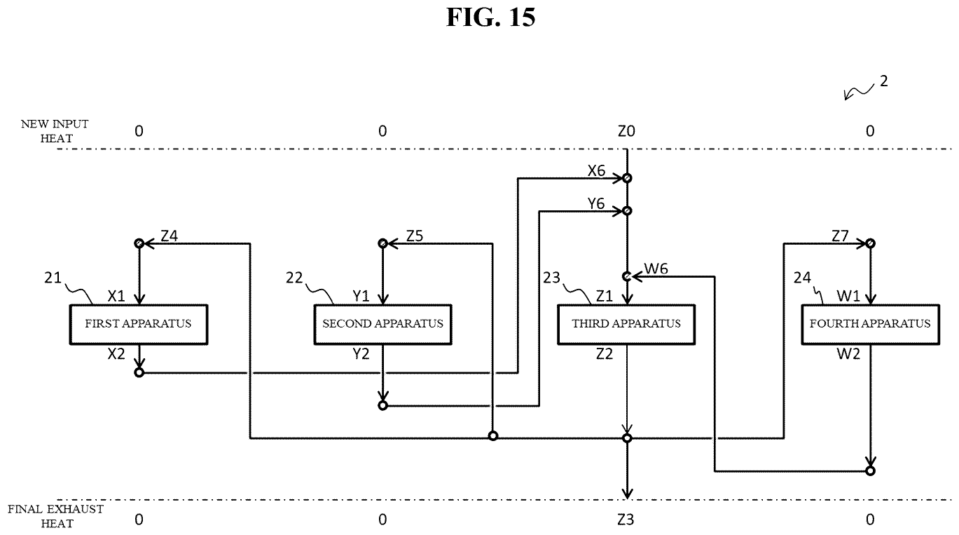

FIG. 15 is a diagram for explaining an operation in the plant 2 for shutdown.

As shown in FIG. 15, the temperature control unit 13 supplies the first apparatus 21 with a heat quantity Z4 of a portion of thermal fluid heated by the third apparatus 23. The first apparatus 21 is supplied with a heat quantity X1 equivalent to the heat quantity Z4. The first apparatus 21 heats the thermal fluid and outputs a heat quantity X2. The thermal fluid having the heat quantity X2 is supplied to the third apparatus 23. Thus, the heat quantity X2 is equal to the heat quantity X6.

The temperature control unit 13 supplies the second apparatus 22 with a heat quantity Z5 of a portion of the thermal fluid heated by the third apparatus 23. The second apparatus 22 is supplied with a heat quantity Y1 equivalent to the heat quantity Z5. Thus, the heat quantity Z5 is equal to the heat quantity Y1. The second apparatus 22 heats the thermal fluid and outputs a heat quantity Y2. The thermal fluid having the heat quantity Y2 is supplied to the third apparatus 23. Thus, the heat quantity Y2 is equal to a heat quantity Y6.

The temperature control unit 13 supplies the third apparatus 23 with a natural gas in an amount equivalent to a heat quantity Z0, with a heat quantity X6 of a portion of the thermal fluid heated by the first apparatus 21, and with the heat quantity Y6 of a portion of the thermal fluid heated by the second apparatus 22. Thus, the sum of the heat quantities (Z0+X6+Y6) is equal to the heat quantity Z1 input to the third apparatus 23. The third apparatus 23 heats the thermal fluid and outputs a heat quantity Z2. The thermal fluid having the heat quantity Z2 is supplied to the first apparatus 21, the second apparatus 22, and the fourth apparatus 24, and a remaining heat quantity Z3 is discharged as exhaust heat. Thus, the heat quantity Z2 is equal to the sum of the heat quantities (Z4+Z5+Z7+Z3).

The temperature control unit 13 supplies the fourth apparatus 24 with a portion of the thermal fluid heated by the third apparatus 23, thereby supplying the fourth apparatus 24 with a heat quantity Z7. A heat quantity W1 on the input side of the fourth apparatus 24 is equal to the heat quantity Y7. The fourth apparatus 24 heats the thermal fluid and outputs a heat quantity W2. The thermal fluid having the heat quantity W2 is supplied to the third apparatus 23. Thus, the heat quantity W2 is equal to the heat quantity W6.

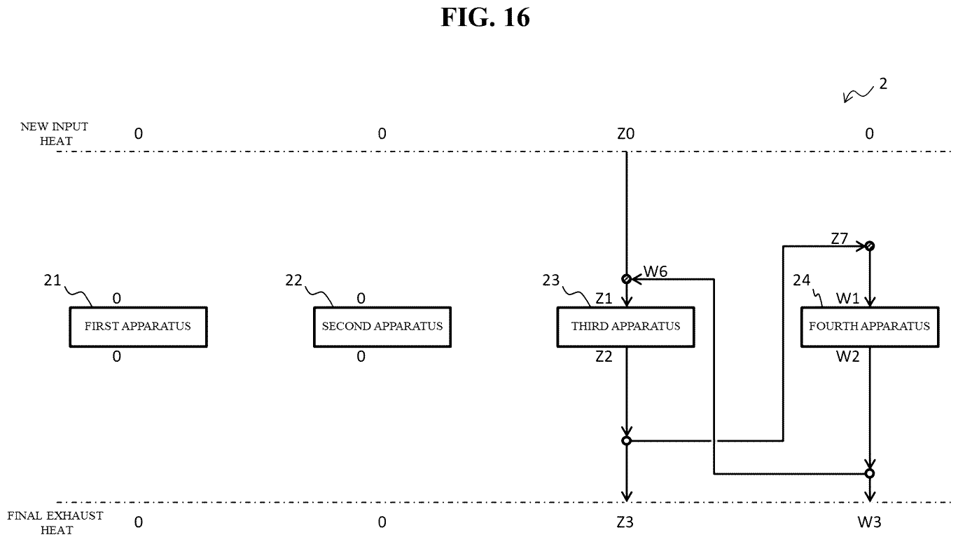

FIG. 16 is a diagram for explaining an operation in the plant 2 for shutdown after the first apparatus 21 and the second apparatus 22 are stopped.

As shown in FIG. 16, the temperature control unit 13 supplies the third apparatus 23 with a natural gas in an amount equivalent to a heat quantity Z0, and with a heat quantity W6 of a portion of thermal fluid heated by the fourth apparatus 24. Thus, the sum of the heat quantities (Z0+W6) is equal to a heat quantity Z6 input to the third apparatus 23. The third apparatus 23 heats the thermal fluid and outputs a heat quantity Z2. A portion of the thermal fluid having the heat quantity Z2 is supplied to the fourth apparatus 24 and a heat quantity Z3 of the remaining thermal fluid is discharged as exhaust heat. Thus, the heat quantity Z2 is equal to the sum of the heat quantities (Z7+Z3).

The temperature control unit 13 supplies the fourth apparatus 24 with a portion of the thermal fluid heated by the third apparatus 23, thereby supplying the fourth apparatus 24 with a heat quantity Z7. A heat quantity W1 on the input side of the fourth apparatus 24 is equal to the heat quantity Y7. The fourth apparatus 24 heats the thermal fluid and outputs a heat quantity W2. A portion of the thermal fluid having the heat quantity W2 is supplied to the third apparatus 23 and a heat quantity W3 of the remaining thermal fluid is discharged as exhaust heat. Thus, the heat quantity W2 is equal to the sum of the heat quantities (W6+W3).

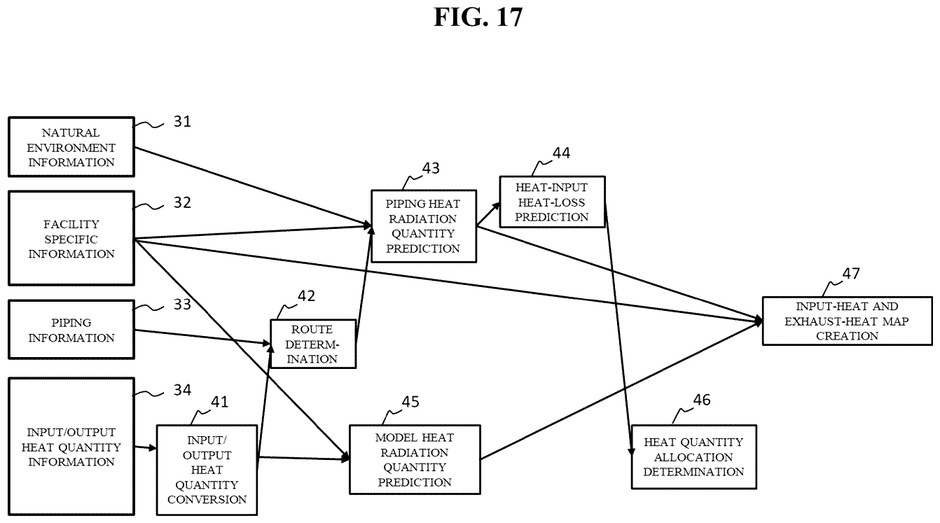

FIG. 17 is a diagram showing process layers for calculating a piping heat radiation quantity.

As shown in FIG. 17, the heat radiation quantity calculation unit 12 executes input/output heat quantity conversion processing 41 by using input/output heat quantity information 34. The heat radiation quantity calculation unit 12 executes route determination processing 42 by using piping information 33 and a result of the input/output heat quantity conversion processing 41. The heat radiation quantity calculation unit 12 performs piping heat radiation quantity prediction processing 43 using natural environment information 31, facility specific information 32, and a result of the route determination processing 42. The heat radiation quantity calculation unit 12 performs model heat radiation quantity prediction processing 45 by using the result of the input/output heat quantity conversion processing 41 and the facility specific information 32.

The heat radiation quantity calculation unit 12 performs heat-input heat-loss prediction processing 44 by using a result of the piping heat radiation quantity prediction processing 43. The heat radiation quantity calculation unit 12 performs heat quantity allocation determination processing 46 by using a result of the heat-input heat-loss prediction processing 44. Further, the heat radiation quantity calculation unit 12 performs input-heat and exhaust-heat map creation processing 47 by using the result of the piping heat radiation quantity prediction processing 43, the facility specific information 32, and a result of the model heat radiation quantity prediction processing 45.

### Embodiment Including Heat Reserve Unit

Hereinafter, an embodiment including a heat reserve unit capable of reserving a heat quantity to be supplied to a target will be described. In a case where a supplier-side facility is planned to supply a heat quantity to a target by thermal fluid, the heat reserve unit is controlled to reserve heat if there is a gap between a stop time of the supplier-side facility and a startup time of the target receiving the heat quantity which the thermal fluid supplied from the supplier-side facility has.

Use of the heat reserve unit makes it possible to reserve heat when there is a surplus of the heat quantity to be supplied to the target, that is, when the target's heat demand quantity is low. Then, the heat reserved in the heat reserve unit can be supplied when the heat demand quantity of the target increases. In other words, in a case where all the exhaust heat cannot be supplied at one time, a heat quantity that can be reserved and released and suitable heat reserve/release timing can be calculated.

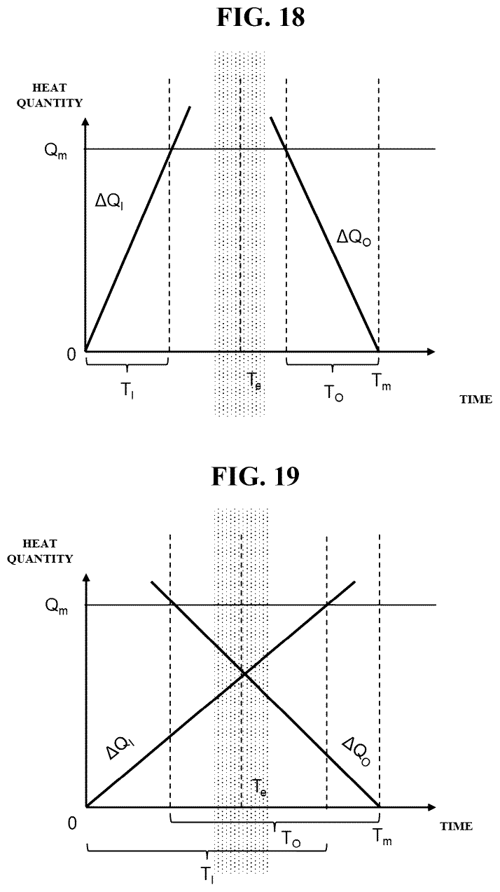

FIG. 18 is a graph showing an operation pattern A for heat reserve and release by the heat reserve unit.

In FIG. 18, the vertical axis in the graph indicates a heat quantity in the heat reserve unit. The horizontal axis in the graph indicates a time. Solid lines in the graph indicate the heat quantity reserved in the heat reserve unit. A heat quantity Qₙ indicates a heat quantity necessary for restarting an operation of a target.

A period T_{I} is a period in which the heat reserve unit is heated by the supply-side facility and the slope of the reserved heat quantity in this period is ΔQᵣ. A period T_{O} is a period in which the heat reserve unit releases the heat to the target and the slope of the reserved heat quantity in this period is ΔQ_{O}. In this operation pattern A, the period T_{I} and the period T_{O} do not overlap each other as expressed by Formula (1).

$$[ Formula 1 ]$$

$${T}_{m} \geq {T}_{I} + {T}_{o} \qquad ( 1 )$$

Switching from heat reserve in the heat reserve unit to hear release from the heat reserve unit at any timing within a hatched portion between the period T_{I} and the period T_{O} makes it possible to make maximum use of the reserved heat quantity in the heat reserve unit. The switching timing herein is a time point Tₑ.

Specifically, when the conditions of above Formula (1) and Formula (2) are satisfied, it is advisable to switch from heat reserve to heat release at a time point Tₑ that satisfies Formula (3).

$$[ Formula 2 ]$$

$${Q}_{n} \leq {T}_{m} \cdot \frac{{ΔQ}_{I} \cdot {ΔQ}_{o}}{{ΔQ}_{I} + {ΔQ}_{o}} \qquad ( 2 )$$

$$[ Formula 3 ]$$

$${T}_{I} < {T}_{e} < {T}_{m} - {T}_{o} \qquad ( 3 )$$

Thermal fluid and its temperature and heat reserve performance during the heat reserve and release for each target apparatus are tested in advance and parameters thus obtained are provided to the temperature control unit 13, so that the temperature control unit 13 can control the switching at optimal heat reserve/release timing.

FIG. 19 is a graph showing an operation pattern B of heat reserve and heat release of the heat reserve unit.

In this operation pattern B, the period T_{I} and the period T_{O} overlap each other as expressed by Formula (4).

$$[ Formula 4 ]$$

$${T}_{m} < {T}_{I} + {T}_{o} \qquad ( 4 )$$

Specifically, when the conditions of above Formula (4) and Formula (5) are satisfied, it is advisable to switch from heat reserve to heat release at a time point Tₑ that satisfies Formula (6).

$$[ Formula 5 ]$$

$${Q}_{n} > {T}_{m} \cdot \frac{{ΔQ}_{I} \cdot {ΔQ}_{o}}{{ΔQ}_{I} + {ΔQ}_{o}} \qquad ( 5 )$$

$$[ Formula 6 ]$$

$${T}_{e} = {T}_{m} \cdot \frac{{ΔQ}_{o}}{{ΔQ}_{I} + {ΔQ}_{o}} \qquad ( 6 )$$

Thus, according to the present embodiment, it is possible to set an optimum heat exchange combination among facilities so as to maximize the heat quantities to be supplied to facilities to be heated. Moreover, utilization of exhaust heat makes it possible to reduce carbon dioxide emission.

In addition, since the input/exhaust amounts are quantified by numerical values, it is possible to handle any types of energy sources. Further, it is also possible to define a standard exhaust heat utilization method that is independent of scale, time, region, and people. Furthermore, it is possible to derive an optimal solution for large-scale, high-speed heat utilization routes beyond the scale and speed of human calculation ability.

The present invention has been described above based on the embodiments, but the present invention is not limited to the constituents described in the above embodiments, and the constituents can be changed as appropriate without departing from the spirit of the present invention, including appropriately combining or selecting the constituents described in the embodiments.

For example, the above embodiments are not limited to the system that provides the hot energy to a target, but may be also applied to a system that provides cold energy to targets.

Hereinafter, the configurations and effects of the present invention will be summarized.
[1] A thermal fluid combination optimization apparatus (1) comprising:
   a temperature control unit (13) configured to supply at least one of types of first thermal fluid, each type having exchanged heat with a corresponding one of supply-side facilities, to any of targets and to perform control to bring a temperature of the any of the targets to a target temperature of the any of the targets; and
   an optimization unit (11) configured to optimize a combination of one of the targets and an amount of first thermal fluid having exchanged heat with one of the supply-side facilities so as to maximize a total sum of heat quantities to be supplied to the targets.

This makes it possible to set an optimum heat exchange combination among facilities so as to maximize the heat quantities to be supplied to facilities to be heated.
[2] The thermal fluid combination optimization apparatus (1) according to claim 1, wherein
   the temperature control unit (13) is configured to perform heat exchange processing of each of the targets in descending order of a corresponding target temperature of each of the targets by using one of types of first thermal fluid, each type having exchanged heat with a corresponding one of the supply-side facilities, and
   the temperature control unit (13) is further configured to repeat performing the heat exchange processing by selecting each of the types of the first thermal fluid as the one of the first thermal fluid in ascending order of a temperature of each of the supply-side facilities.

This makes it possible to reutilize the exhaust heat efficiently with a small amount of calculation.
[3] The thermal fluid combination optimization (1) apparatus according to claim 1, wherein
   each of the targets is heated by any of types of second thermal fluid having exchanged heat via a heat exchanger with first thermal fluid, each of types of the first thermal fluid having exchanged heat with a corresponding one of the supply-side facilities, and
   based on physical property data of the first thermal fluid and physical property data of one type of second thermal fluid, the optimization unit (11) is configured to cause a predetermined amount of the first thermal fluid to exchange heat with the second thermal fluid of the same type as the first thermal fluid and to subsequently causes a remaining amount of the first thermal fluid to exchange heat with the second thermal fluid of a different type of the first thermal fluid.

Since the same type of thermal fluid are combined first in this way, it is possible to reutilize the exhaust heat efficiently.
[4] The thermal fluid combination optimization apparatus (1) according to claim 3 further comprising a heat radiation quantity calculation unit (12) configured to calculate a heat radiation quantity released until a corresponding heat quantity of each of the supply-side facilities is supplied to each of the targets according to a length of piping allowing each of types of the first thermal fluid and/or each of types of the second thermal fluid to flow through the piping, wherein
   the optimization unit (11) is further configured to optimize a combination of one of the targets and an amount of any of the types of the first thermal fluid by using a heat radiation quantity calculated by the heat radiation quantity calculation unit (12).

This makes it possible to optimize the combination between the amounts of the first thermal fluid which have exchanged heat respectively with the plurality of supply-side facilities and the targets, taking the piping heat radiation into account.
[5] The thermal fluid combination optimization apparatus (1) according to claim 2, wherein
   the optimization unit (11) is further configured to change a type of and an amount of first thermal fluid supplied to each of the targets according to environment information under which each of the targets is operated.

This makes it possible to optimize the combination between the amounts of the first thermal fluid which have exchanged heat respectively with the plurality of supply-side facilities and the targets.
[6] The thermal fluid combination optimization apparatus (1) according to claim 5, wherein
   in a case where the optimization unit (11) changes a type of and an amount of first thermal fluid supplied to one of the targets, the temperature control unit (13) is further configured to switch a route configured to supply the first thermal fluid.

This makes it possible to optimize the combination between the amounts of the first thermal fluid which have exchanged heat respectively with the plurality of supply-side facilities and the targets according to the environment information.
[7] The thermal fluid combination optimization apparatus (1) according to claim 5, wherein
   the environment information includes any of date and time information, weather information, barometric pressure information, and temperature and humidity information.

This makes it possible to optimize the combination between the amounts of the first thermal fluid which have exchanged heat respectively with the plurality of supply-side facilities and the targets in response to a change in any of the date and time information, the weather information, the barometric pressure information, and the temperature and humidity information.
[8] The thermal fluid combination optimization apparatus (1) according to claim 7, further comprising a heat reserve unit configured to reserve a heat quantity of the first thermal fluid, wherein
   the environment information includes date and time information, and
   in a case where a target heated by the first thermal fluid is started to operate upon lapse of a predetermined period of time after a supply-side facility for heating the first thermal fluid is stopped, the temperature control unit (13) is further configured to cause the heat reserve unit to reserve heat.

This makes it possible to utilize exhaust heat even if there is a time gap between generation timing and utilization timing of the exhaust heat.
[9] The thermal fluid combination optimization apparatus (1) according to claim 8, wherein
   in a case where the heat reserve unit does not reserve a heat quantity necessary for a target in a period between a stop time point of a supply-side facility and an operation start time point of the target, the temperature control unit (13) is further configured to switch from heat exchange between first thermal fluid having exchanged heat with the supply-side facility and the heat reserve unit to heat exchange between thermal fluid having exchanged heat with the heat reserve unit and the target at any timing within the period between the stop time point of the supply-side facility and the operation start time point of the target.

This makes it possible to suitably utilize exhaust heat even if there is a time gap between generation timing and utilization timing of the exhaust heat.
[10] A thermal fluid combination optimization method comprising:
   causing an optimization unit (11) to optimize a combination of one of targets and an amount of first thermal fluid having exchanged heat with one of supply-side facilities so as to maximize a total sum of heat quantities to be supplied to the targets; and
   causing a temperature control unit (13) configured to supply at least one of types of first thermal fluid, each type having exchanged heat with a corresponding one of supply-side facilities, to any of targets and to perform control to bring a temperature of the any of the targets to a target temperature of the any of the targets.

This makes it possible to set an optimum heat exchange combination among facilities so as to maximize the heat quantities to be supplied to facilities to be heated.
[11] A non-transitory recording medium recording a thermal fluid combination optimization program causing a computer to perform:
   optimizing a combination of one of targets and an amount of first thermal fluid having exchanged heat with one of supply-side facilities so as to maximize a total sum of heat quantities to be supplied to the targets;
   supplying at least one of types of first thermal fluid, each type having exchanged heat with a corresponding one of supply-side facilities, to any of targets; and
   performing control to bring a temperature of the any of the targets to a target temperature of the any of the targets.

This makes it possible to set an optimum heat exchange combination among facilities so as to maximize the heat quantities to be supplied to facilities to be heated.

It is understood that the foregoing description is that of the preferred embodiments of the invention and that various changes and modifications may be made thereto without departing from the spirit and scope of the invention as defined in the appended claims.

What is claimed is:

1. A thermal fluid combination optimization apparatus comprising:
a temperature control unit configured to supply at least one of types of first thermal fluid, each type having exchanged heat with a corresponding one of supply-side facilities, to any of targets and to perform control to bring a temperature of the any of the targets to a target temperature of the any of the targets; and
an optimization unit configured to optimize a combination of one of the targets and an amount of first thermal fluid having exchanged heat with one of the supply-side facilities so as to maximize a total sum of heat quantities to be supplied to the targets.

2. The thermal fluid combination optimization apparatus according to claim 1, wherein
the temperature control unit is configured to perform heat exchange processing of each of the targets in descending order of a corresponding target temperature of each of the targets by using one of types of first thermal fluid, each type having exchanged heat with a corresponding one of the supply-side facilities, and
the temperature control unit is further configured to repeat performing the heat exchange processing by selecting each of the types of the first thermal fluid as the one of the first thermal fluid in ascending order of a temperature of each of the supply-side facilities.

3. The thermal fluid combination optimization apparatus according to claim 1, wherein
each of the targets is heated by any of types of second thermal fluid having exchanged heat via a heat exchanger with first thermal fluid, each of types of the first thermal fluid having exchanged heat with a corresponding one of the supply-side facilities, and
based on physical property data of the first thermal fluid and physical property data of one type of second thermal fluid, the optimization unit is configured to cause a predetermined amount of the first thermal fluid to exchange heat with the second thermal fluid of the same type as the first thermal fluid and to subsequently causes a remaining amount of the first thermal fluid to exchange heat with the second thermal fluid of a different type of the first thermal fluid.

4. The thermal fluid combination optimization apparatus according to claim 3 further comprising a heat radiation quantity calculation unit configured to calculate a heat radiation quantity released until a corresponding heat quantity of each of the supply-side facilities is supplied to each of the targets according to a length of piping allowing each of types of the first thermal fluid and/or each of types of the second thermal fluid to flow through the piping, wherein
the optimization unit is further configured to optimize a combination of one of the targets and an amount of any of the types of the first thermal fluid by using a heat radiation quantity calculated by the heat radiation quantity calculation unit.

5. The thermal fluid combination optimization apparatus according to claim 2, wherein
the optimization unit is further configured to change a type of and an amount of first thermal fluid supplied to each of the targets according to environment information under which each of the targets is operated.

6. The thermal fluid combination optimization apparatus according to claim 5, wherein
in a case where the optimization unit changes a type of and an amount of first thermal fluid supplied to one of the targets, the temperature control unit is further configured to switch a route configured to supply the first thermal fluid.

7. The thermal fluid combination optimization apparatus according to claim 5, wherein
the environment information includes any of date and time information, weather information, barometric pressure information, and temperature and humidity information.

8. The thermal fluid combination optimization apparatus according to claim 7, further comprising a heat reserve unit configured to reserve a heat quantity of the first thermal fluid, wherein
the environment information includes date and time information, and
in a case where a target heated by the first thermal fluid is started to operate upon lapse of a predetermined period of time after a supply-side facility for heating the first thermal fluid is stopped, the temperature control unit is further configured to cause the heat reserve unit to reserve heat.

9. The thermal fluid combination optimization apparatus according to claim 8, wherein
in a case where the heat reserve unit does not reserve a heat quantity necessary for a target in a period between a stop time point of a supply-side facility and an operation start time point of the target, the temperature control unit is further configured to switch from heat exchange between first thermal fluid having exchanged heat with the supply-side facility and the heat reserve unit to heat exchange between thermal fluid having exchanged heat with the heat reserve unit and the target at any timing within the period between the stop time point of the supply-side facility and the operation start time point of the target.

10. A thermal fluid combination optimization method comprising:
causing an optimization unit to optimize a combination of one of targets and an amount of first thermal fluid having exchanged heat with one of supply-side facilities so as to maximize a total sum of heat quantities to be supplied to the targets; and
causing a temperature control unit configured to supply at least one of types of first thermal fluid, each type having exchanged heat with a corresponding one of supply-side facilities, to any of targets and to perform control to bring a temperature of the any of the targets to a target temperature of the any of the targets.

11. A non-transitory recording medium recording a thermal fluid combination optimization program causing a computer to perform:
optimizing a combination of one of targets and an amount of first thermal fluid having exchanged heat with one of supply-side facilities so as to maximize a total sum of heat quantities to be supplied to the targets;
supplying at least one of types of first thermal fluid, each type having exchanged heat with a corresponding one of supply-side facilities, to any of targets; and
performing control to bring a temperature of the any of the targets to a target temperature of the any of the targets.
